(19) United States
(12) Patent Application Publication
(10) Pub. No.: US 2026/0002482 A1
(43) Pub. Date: Jan. 1, 2026

(54) METHOD AND DEVICE FOR QUICKLY SHIFTING THE GEAR OF THE ENGINE OF A MOTORCYCLE

(71) Applicant: DUCATI MOTOR HOLDING S.P.A., Bologna (BO) (IT)

(72) Inventors: Marco FORCONI, Bagno a Ripoli (FI) (IT); Duccio DORETTI, Bologna (BO) (IT); Ottavio D’ELIA, Casalecchio di Reno (BO) (IT); Pierluigi ZAMPIERI, Sasso Marconi (BO) (IT); Simone DI PIAZZA, Bologna (BO) (IT)

(73) Assignee: DUCATI MOTOR HOLDING S.P.A., Bologna (BO) (IT)

(21) Appl. No.: 19/247,615

(22) Filed: Jun. 24, 2025

(30) Foreign Application Priority Data
Jul. 1, 2024 (IT) 102024000015088

(51) Int. Cl. F02D 41/02; B62M 25/00; B62M 25/08

(52) U.S. Cl. CPC F02D 41/0225; B62M 25/08; F02D 41/023; B62M 2025/003

(57) ABSTRACT

A method for quickly shifting the gear of an engine of a motorcycle having a gear assembly provided with a rotary member for selecting the gear, provides for detecting the position of such rotary member during the gear shift and with the gear engaged, identify the electrical signals detected by a special sensor functionally associated with such rotary member and relating to such position, detecting a predefined electrical signal value between the identified electrical signals and shifting the gear when such predefined signal value is achieved following an action of the rider on a gear lever. Furthermore, disclosed is the system for implementing such method.

The present invention relates to a method and a system for quickly shifting the gear of an engine of a motorcycle according to the preamble of the corresponding independent claim. The characteristics in such preamble are disclosed in US2019/0264803.

Methods and systems adapted to allow to quickly shift gears of an engine of a motorcycle (“quickshift” systems) have long been known. Usually, such systems use two sensors or switches for activating a methodology (or “strategy”) for shifting gears that is with an increase of the gear (upshift) and with a decrease of the gear (downshift). In particular, a prior art solution provides for a dedicated gear shift sensor which detects the action of the rider of the vehicle on the usual gear pedal lever and generates an analogue signal directed to a control unit (or a command and control unit) of the vehicle engine. The latter interprets such signal as a gear shift request by the rider and if appropriate pre-conditions (such as for example the operation is sufficiently distant from the idling speed or the overspeed limitation operation, or the complete engagement of the clutch) are met, such control unit acts on the engine to allow the quickshift.

Furthermore, in the prior art solution, a second sensor is arranged on the rotary member or selector drum of the gearbox; such second sensor verifies whether the shift strategy, upshift or downshift, is activated correctly and whether the operation is completed as expected.

For the methods with which the prior art quickshift systems are made, they may be significantly costly (even due to the use of the double sensor and the electronics correlated to the sensors which enables the effective use thereof) and they are also quite expensive due to the possible operations for the maintenance or repair of failures often linked to each sensor used.

Furthermore, the prior art systems may have relatively long intervention times, and this is not acceptable in motorcycle racing, and give the rider a resistance feeling when shifting gears also due to the presence, in said solutions, of an elastic element between the gear lever and the gearbox selector drum.

An object of the present invention is to provide an improved method and system for quickly shifting gears in a motorcycle.

In particular, an object of the present invention is to provide a method and a system for quickly shifting the gear of an engine of a motorcycle which gives the rider an improved feeling with respect to that given by the prior art solutions, both when shifting and when disengaging the gear to neutral.

Another object is to provide a system and a method of the type mentioned above which enable to make the gear shift (or “shifting”) as repeatable as possible, especially in sports mode/racing use so as to have an excellent control of the vehicle.

A further object is to provide a system and a method of the type mentioned above which always provides for shifting gears with the “quickshift” strategy even with low revolutions or loads of the engine.

A further object of the present invention is to provide a method and a system for quickly shifting gears which allow the mechanical members of the gearbox to be effectively prepared to shift gears as soon as the rider starts the action on the gear lever, ensuring very short action times.

A further object is to provide a system for shifting gears with the quickshift mode that is more cost-effective than that of systems that are similar and already known and that is highly reliable.

These and other objects which shall be apparent to the person skilled in the art are attained by a method and by a system according to the corresponding independent claims.

For a better understanding of the present invention, the following drawings are attached hereto, purely by way of non-limiting example, wherein:

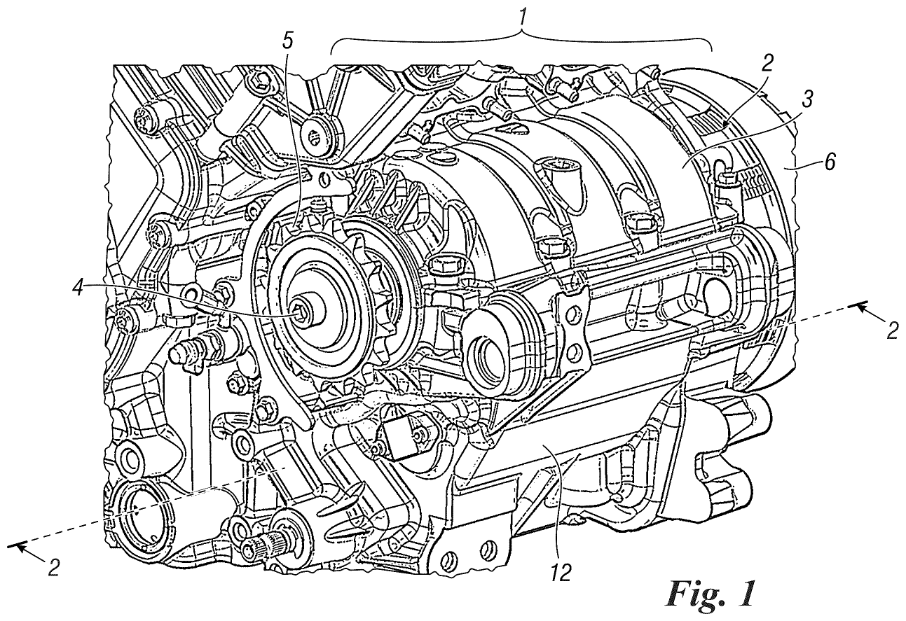

FIG. 1 shows a detail of an engine of a motorcycle having a gear assembly where the present invention is implemented;

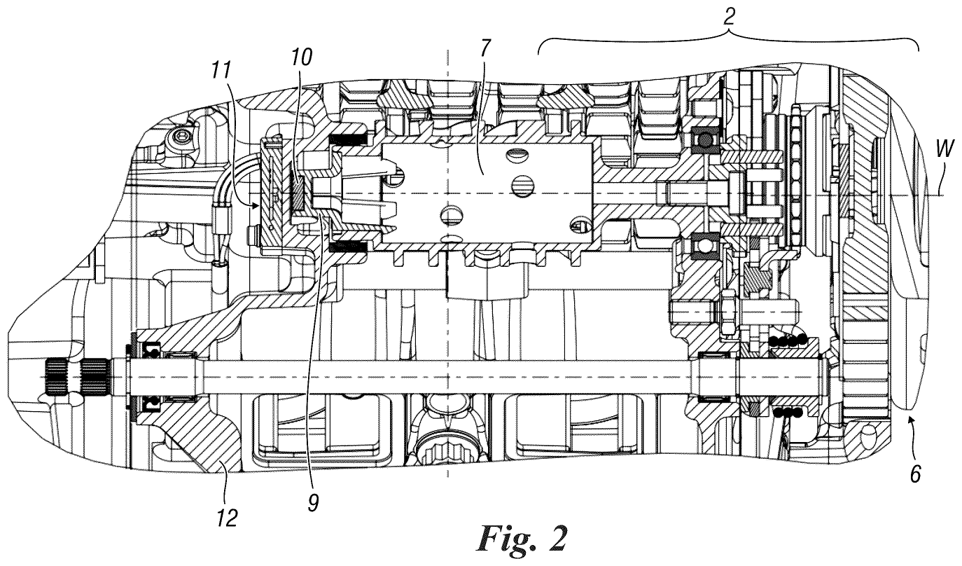

FIG. 2 shows a sectional view according to line 2-2 of FIG. 1;

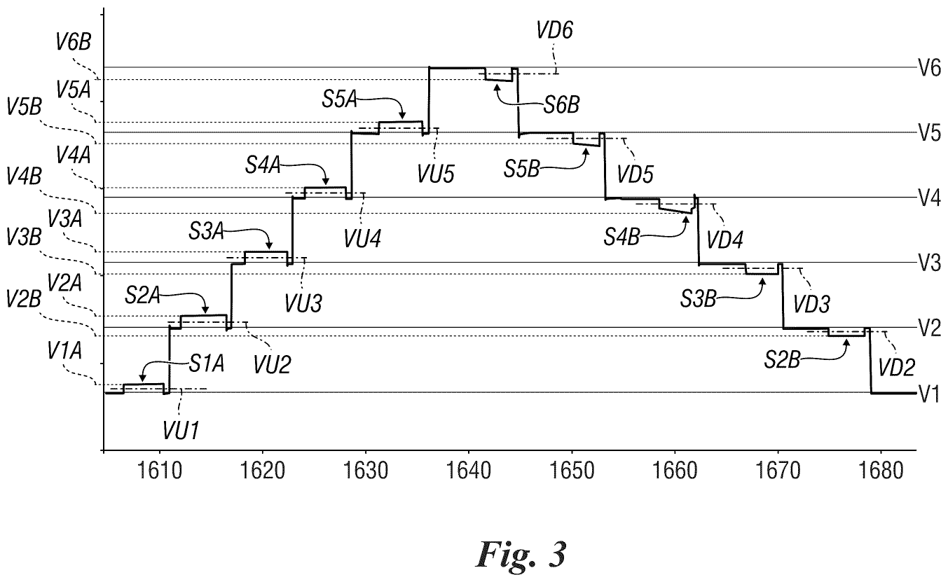

FIG. 3 shows a chart of the development of the voltage measured by the gearbox drum sensor when the rider actuates the gear lever without removing the torque applied to the engagements, from said figure there being observable a possible implementation mode of the method according to the invention;

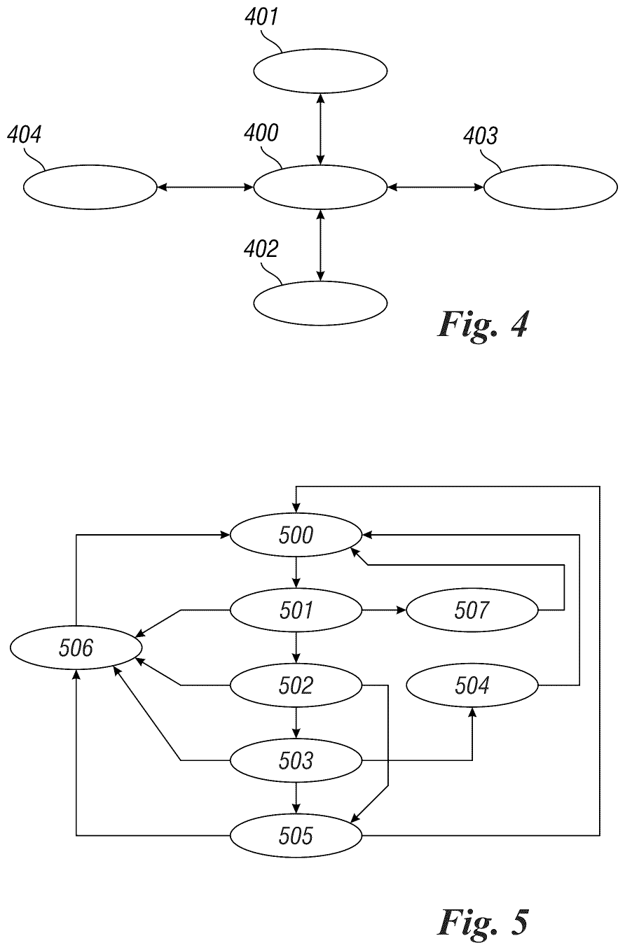

FIG. 4 shows a general block flow diagram of the steps for implementing the method according to the invention; and

FIG. 5 shows, in a diagram, an example of the steps for implementing the method according to the invention.

With reference to FIGS. 1 and 2 mentioned above they partially show an engine or drive unit 1 of a motorcycle. Such engine is controlled by a control unit or ECU per se known (not shown), operating in a per se known manner. Therefore, except for aspects relating to the present invention and which will be reported below in the present document, such operating modes of the ECU will not be further described below.

The engine 1 comprises a gear assembly 2 having an outer casing 3 from which there protrudes a shaft 4 on which there is keyed a gearwheel 5 for transferring the motion to a usual member for transmitting the power supplied by the engine 1 to the rear wheel of the vehicle (not shown). In a known manner, the gear assembly has a usual clutch 6 and a rotary member or selector drum of the gearbox 7 of the per se known type and adapted to allow, through the cooperation thereof with usual selector elements (“or forks”, not shown), to shift the engine gear. The member or drum of the gearbox 7 is adapted to rotate around a longitudinal axis W thereof and it carries at an end 9 thereof a body 10 adapted to cooperate with a sensor 11 arranged on the crankcase 12 of the engine 1. In particular, in an embodiment, such body 10 is a magnet and the sensor 11 is a Hall-effect sensor.

Said body 10 and the sensor 11 (connected to the ECU indicated above) allow to detect the angular condition of the drum of the gearbox 7 around the axis thereof and detect the engaged gear.

The sensor 11 generates a voltage signal at each engaged gear. FIG. 3 shows various signals V1, V2, V3, V4, V5 and V6 generated by the sensor 11 and sent to the ECU of the engine which identify each engaged gear; hereinafter, we will indicate each of such values as the “idle voltage value of each gear” (there are provided for six engageable gears in this case).

Such voltage values, gear by gear, are self-learnt by the ECU and therefore they are stored by the latter.

Whenever a rider shifts a gear by acting on the usual gear lever, during the movement of the lever, the known components of the gear assembly 2 move to allow the disengagement of the current gear and the engagement of the desired gear; as long as the current gear is not disengaged, between the components of the gear assembly there is a clearance adjustment which is shown in FIG. 3. This clearance adjustment leads to a change in the signal of the sensor 11 up to the values indicated in FIG. 3 with S1A, S2A, S3A, S4A, S5A in the event of upshift and with S6B, S5B, S4B, S3B and S2B in the event of downshift. The signal generated by the sensor 11 during clearance adjustment may reach a maximum (upshift) or minimum (downshift) voltage value indicated in FIG. 3 as V1A, V2A, V3A, V4A, V5A during upshift and V6B, V5B, V4B, V3B and V2B during downshift. Such voltage values will be indicated as “clearance recovery voltage values”.

The sign of the change in the signal generated by the sensor 11, increasing or reducing with respect to the idle voltage value, allows the ECU to establish whether the gear shift should be a downshift or an upshift given that such sign identifies the direction of the force that the rider applies to the gear lever.

Between each idle voltage and the corresponding clearance recovery voltage (for example between V1 and V1A or between V1 and V2B) there is therefore a voltage difference or delta. This is due to mechanical factors related to the design of the selector drum and in particular due to the usual tracks present on the latter which guide the movement of the “forks” and the tolerance of the various couplings of the mechanical members of the gear assembly.

In order to allow a quickshift according to the present invention, within each voltage delta indicated above there is set a threshold which is shown with a dashed line in FIG. 3 which is indicated as VU1, VU2, VU3, VU4 and VU5 in the event of an upshift, and as VD6, VD5, VD4, VD3 and VD2 in the event of a downshift.

Each voltage threshold represents a corresponding gear shift (upshift or downshift) threshold for each gear. Each voltage threshold value is therefore predefined and fixed.

Therefore, with reference to FIGS. 4 and 5, when the rider uses the motorcycle with a specific gear engaged, the method according to the invention remains in standby 400. When the rider acts on the gear lever for upshift or downshift (obviously depending on the gear already engaged), the sensor 11 detects the start of rotation of the drum of the gearbox 7 which corresponds to the generation of a voltage signal which exceeds, in upshift or downshift, the voltage threshold that is pre-established and indicated above.

The exceeding (in upshift or downshift) of such threshold value is detected by the ECU which acts on the engine so that it generates the torque dynamics required to accept and support such gear shift.

It should be observed that the threshold value for each gear is suitably calibrated for each gear and, changes depending on the gear. This also allows to differentiate the promptness of the system on different gears calibrating the threshold differently.

In particular, the threshold value is selected so as not to be too close to the idle voltage value so as to avoid the risks of activation of the gear shift should the rider touch the gear lever, but sufficiently close to such value so as to have a certain promptness of the system (comprising the body 10 associated with the drum of the gearbox 7, the sensor 11 and the ECU of the vehicle) upon activating the methodology of the gear shift, and to still have an actuation of the gear shift that is as “soft” as possible.

Furthermore, such threshold value is not even too close to the clearance recovery voltage values so as to avoid lesser promptness of the system in activating the gear shift methodology, but sufficiently close to be sure to clearly detect the intention of the rider to activate such methodology, so as to prevent the gear shift to be perceived as “hard” and so as to avoid to fail to achieve the threshold, should the mechanical tolerances be lower than expected.

Therefore, each threshold value is suitably identified as a percentage of the voltage difference (signal detected by the sensor 11 between the stable position and the clearance recovery position. Depending on the gear, this value may be suitably calibrated to obtain determined behaviour: greater or lesser promptness of the system and corresponding greater or lesser strength in detecting the intention of the rider to shift gears. The values are defined using appropriate tests on the vehicle and they may also change from one application to another.

Returning to FIGS. 4 and 5, FIG. 4 shows that from the standby condition or step 400, depending on the action of the rider on the gear lever, the method provides for switching to an upshift step or to a downshift step. In order to shift gears first and foremost so as to avoid damaging the mechanics of the transmission and still complete the operation, the gear can be shifted generating suitable torque dynamics which allow to disengage the engaged gear depending on the driving situation, generating or reducing the torque applied at the time of request by the rider.

FIG. 4 shows with a block flow diagram the method according to the invention due to which, from a standby step 400 there can be obtained an upshift (in the usual manner that is when driving with torque delivery by the engine, or when driving in a driven fashion that is without torque delivery by the engine, blocks 401 and 402) or a downshift (still in the usual manner therefore in a driven fashion, or in a driving fashion with drive torque delivery generated by the engine at the time of gear shift request by the rider, blocks 403 and 404). The distinction between upshift (blocks 401 and 402) of downshift (blocks 403 and 404) occurs depending on the development of the signal detected by the sensor 11. The distinction between driven operation (blocks 402 and 404) and torque delivery operation (401 and 403) is carried out depending on the torque requested by the rider using the usual accelerator knob at the time of the start of the gear shift.

FIG. 5 more specifically shows the method according to which the system according to the invention operates that is the method subject of the invention.

In step 500, the motorcycle moves with a gear engaged and the rider does not request (or has requested) any gear shift.

In step 500, the rider manifests the intention to shift gears (at the initial time of the movement of the gear lever); such detection occurs through the sensor 11 which detects an initial movement of the body 10 associated with the drum of the gearbox 7 which starts a rotation around its axis W.

With reference to FIG. 3, for example such detection occurs by generating a voltage signal K between two voltage signals corresponding to the engaged gear and to the target or shift gear: in the example, the motorcycle moves with gear four engaged and the signal K causes a change in the voltage emitted by the value sensor V4 to the value VU4 in the event of an upshift and to the value VD4 in the event of a downshift.

With this detection, the system switches to a step 501 during which the ECU generates the appropriate torque dynamics to disengage the current gear.

It should be observed that in step 500, before switching to step 501 and once the ECU detects a movement of the drum in the downshift direction, there may be activated a sub-step in which there is created a “torque reserve” that is a drive torque surplus to make the gear shift comfortable and so as not to generate excessive stresses on the mechanical members of the gearbox.

Such torque reserve is obtained by the ECU simultaneously advancing the opening of the usual throttle valve of the engine and degrading the advance applied so that the system is more prompt in generating the drive torque as soon as the shift start threshold is achieved and then on to the next step 501. Therefore, it should be observed that by so doing, the ECU does not generate a positive drive torque until the actual gear shift begins.

As mentioned above, the sensor 11 detects the movement of the drum of the gearbox 7 following the action of the rider on the gear pedal and generates the signal K (see FIG. 3, between gear four and five).

When such signal exceeds the value VU4, the ECU detects that the rider is shifting a gear and acts on the engine to modulate the torque thereof. At the same time, the current gear is disengaged due to such torque modulation and the action of the rider on the gear lever.

While the drum of the gearbox continues its rotation around its axis W, the ECU of the vehicle detects the disengagement of the gear through the development of the signal K. When this happens, the system moves to the step 502 shown in FIG. 5.

Furthermore, it should be observed that from step 501 one can move to a step 507 should the ECU detect that the current gear is not disengaged; this through the signal emitted by the sensor 11, which does not exceed the gear disengagement threshold (which is known to the ECU given that it is calibrated depending on the design of the gearbox drum). In this case, the ECU commands the engine so that there are generated torque oscillations to help the drum to return to its stable gear position. This step 507 is maintained until the ECU detects that the drum has returned to its stable gear position or the rider has pulled the clutch lever.

Lastly, it should be observed that when implementing step 501, should the rider slowly move gear lever during a downshift, the positive drive torque generated by the engine could be perceived by the rider as a forward push of the motorcycle. This could happen when during the application of the slight positive drive torque so as to disengage the gear, the rider does not sufficiently push on the lever and does not disengage the engaged gear at the start of the operation as promptly as necessary. As a result, the positive torque is transmitted to the wheel generating an unwanted forward thrust of the vehicle. In this case there is applied an “antipush” action which avoids such forward push suitably reducing the generated torque before there is the impact between the two driven and driving wheels.

During step 502, the ECU supports the engagement of the target gear by suitably generating torque for synchronising the engagements.

From step 502 one can move to a step 505 in which, by monitoring the development of the voltage signal (in the example, when it reaches the value V5) emitted by the sensor 11, the ECU of the vehicle detects the successful engagement of the target gear. During step 505, the ECU returns the applied torque from the one modulated during step 502 to the one requested by the rider using a knob. The vehicle continues with such engaged gear and there is a return to step 500.

However, in case of non-engagement of the target gear (detected by the ECU upon failure to reach the stable threshold of the subsequent gear), the ECU activates a control of the engine to generate an oscillating development of the torque between positive and negative values (with zero average value, so as to avoid impacts on the dynamics of the vehicle) adapted to “shake” the gearbox and try to solve the partial engagement situations on the gears or their failure to be engaged. Such operation is carried out in step 503.

Should the “shaking” of the gearbox of step 503 lead to the engagement of the gear, the system moves on to step 505 described above. Otherwise, the system moves on to step 504 when, upon monitoring the signal emitted by the sensor 11, there is not detected the successful engagement of the target gear within an established time as the limit for the evolution of the gear shift. Such time ranges from 150 to 500 ms depending on the type of gear shift and the engaged gear.

In this step 504, the engine limits the speed to the one that would be reached with the gear engaged until the situation is solved. This so as to avoid the re-engagement of the usual gears of the gear assembly 2 at high speed revolutions, and this could damage the components of the gear.

From this step, the system returns to step 500 when the rider acts on the clutch lever or otherwise engages the target gear or the operation start one.

From each step 501, 502, 503 and 505, the system can also move to a recovery step 506 into which the system enters in case of a failure that occurs during a gear shift. From step 506 the system returns to step 500 after deactivating and restarting the motorcycle by turning a key should the ECU not detect further failures.

The system according to the invention (comprising the body 10, sensor 11, drum 7 and ECU) can therefore allow the gear shift without using sensors associated with the gear lever and detecting the movement of the drum of the gearbox 7 alone. Furthermore, compared to the prior art equivalent solutions, there is no the usual elastic element between the gear lever and the drum with resulting improvement of the feeling that the rider receives when searching for the neutral gear and when actuating the aforementioned lever.

Thanks to the use of the sensor 11 cooperating with the body 10 associated with the drum of the gearbox 7, the gear shift is more repeatable, especially during a use of the motorcycle for sports purposes. Furthermore, the gear shift is always carried out in quickshift mode even at low speed revolutions of the engine or with low loads where with the prior art solutions the sensor arranged on the gear lever cannot detect the action of the rider before completing the gear shift given that there is no resistance to the disengagement by the gearbox and resulting engagement of the gear. Lastly, in particular racing applications, like in the SBK championship, the ECU can be set so that the strategy (method) of application of the quickshift gearbox starts in advance as soon as the rider touches the gear lever with resulting load on the forks which lasts for a limited period of time, shorter than the usual one used currently.

This also enables to obtain a reduction of costs and the operational complexity of the system, a greater reliability with respect to the prior art systems operating the quickshift gearbox and a reduction of the maintenance operations with respect to what occurs with the prior art systems.

A specific embodiment of the invention has been described. However, even other variants possible to the person skilled in the art may be provided in the light of the description above, all falling within the scope of protection that is defined by the claims that follow.

1. A method for shifting a gear in an engine of a motorcycle,
said engine being controlled and commanded in its operation by a control unit,
the engine comprising a gear assembly having a member or drum of the gearbox adapted to rotate around its longitudinal axis (W) so as to actuate elements which select the various gears of the gear assembly, there being provided for a position sensor connected to the control unit adapted to detect various angular positions of said member or drum of the gearbox corresponding to the various gears engaged,
the method comprising the steps of:
the position sensor generating an idle electrical signal (V1, V2, V3, V4, V5, V6) when said member or drum of the gearbox is in stationary position corresponding to an engaged gear, said sensor also generating a clearance recovery electrical signal (V1A, V2A, V3A, V4A, V5A, V2B, V3B, V4B, V5B, V6B) after shifting a gear and before said gear is engaged definitely,
said electrical signals being received by the control unit of the engine which therefore detects a gear shift,
wherein there is defined a threshold value of the electrical signal emitted by the sensor, for each gear (VU1, VU2, VU3, VU4, VU5, VD2, VD3, VD4, VD5, VD6), said threshold value being arranged between the corresponding idle and clearance recovery electrical signals,
the control unit controlling the change of the idle electrical signal generated by the position sensor with respect to the initial idle one generated by the position sensor and,
when such idle electrical signal changes with respect to the initial idle signal and reaches said threshold value, the control unit identifies the intention of the rider to shift the gear, said control unit therefore intervening on the engine so as to prepare the gear shift, said gear shift being considered completed when the position sensor generates an idle electrical signal different from the initial one.

2. The method according to claim 1, wherein the change of the initial idle electrical signal starts when the rider acts on the gear lever.

3. The method according to claim 1, wherein said change of the idle electrical signal is alternatively in the direction of increasing such signal or a decrease thereof.

4. The method according to claim 1, wherein the signal emitted by the position sensor is a voltage signal.

5. The method according to claim 1, wherein said threshold value of the signal emitted by the sensor is defined as the intermediate value between the value of the idle electrical signal and the value of the clearance recovery electrical signal.

6. The method according to claim 5, wherein the threshold value of the signal emitted by the position sensor is calibrated for each gear and changes as a function of the gear.

7. The method according to claim 1, wherein, when the signal generated by the position sensor deviates from the value of the idle signal during the downshift, there is generated a torque reserve of the engine by simultaneously opening the known throttle valve of the engine and adjusting that is downgrading the ignition advance of the engine.

8. The method according to claim 1, wherein the control unit of the engine commands the generation of engine torques oscillating between the positive and negative values should the control unit not detect the successful engagement of a different gear after the gear shift request, said detection being obtained by detecting the development of the signal generated by the sensor which does not reach the stable position of the target gear.

9. The method according to claim 1, wherein there is provided for a step in which there is maintained a pre-set number of revolutions of the engine should the control unit detect the non-engagement of a gear subsequently to the request of the rider to change the initial gear, such maintenance of said number of revolutions lasting for a limited period of time.

10. The method according to claim 1, wherein the control unit commands the engine to generate successive drive torque pulses when it is detected that the gear engaged is not disengaged, said detection occurring upon detecting that the electrical signal does not exceed the gear disengagement threshold, said threshold being known to the control unit of the engine depending on the drawing of the gearbox drum.

11. The method according to claim 1, wherein each idle electrical signal (V1, V2, V3, V4, V5, V6) corresponding to a respective engaged gear is self-learnt by the control unit of the engine.

12. The method according to claim 1, wherein during the downshift should the position sensor detect that the current gear is not disengaged within the expected times, the control unit of the engine intervenes so as to reduce the torque delivered to carry out the operation so as to prevent it from making the vehicle accelerate in an undesired manner.

13. A system for shifting a gear in an engine of a motorcycle, comprising:
a control unit being provided for controlling and commanding the operation of said engine,
the engine comprising a gear assembly having a member or drum of the gearbox adapted to rotate around its longitudinal axis (W) so as to actuate elements which select the various gears of the gear assembly,
there being provided for a position sensor connected to the control unit adapted to detect the various angular positions of a body associated with said member or drum of the gearbox corresponding to the various gears engaged,
the position sensor for generating an idle electrical signal (V1, V2, V3, V4, V5, V6) directed to said control unit when said member or drum of the gearbox is a stationary position corresponding to an engaged gear,
said position sensor also for generating a clearance recovery electrical signal (V1A, V2A, V3A, V4A, V5A, V2B, V3B, V4B, V5B, V6B) after shifting a gear and before said gear is engaged definitely,
the control unit of the engine being adapted to receive said electrical signals generated by the position sensor and therefore detecting a gear shift,
wherein there is defined a threshold value of the electrical signal emitted by the sensor for each gear (VU1, VU2, VU3, VU4, VU5, VD2, VD3, VD4, VD5, VD6), said threshold value being arranged between the corresponding idle and clearance recovery electrical signals,
the control unit controlling the change in an initial idle electrical signal generated by the position sensor and
when such initial idle electrical signal changes and reaches said threshold value, the control unit identifies the intention of the rider to shift the gear, therefore said control unit intervening on the engine so as to prepare the gear shift, said gear shift being considered carried out when the position sensor generates an idle electrical signal different from the initial one.

14. The system according to claim 13, wherein said position sensor is arranged externally on a crankcase of the engine at the gear assembly.

15. The system according to claim 13, wherein the body with which the position sensor cooperates is arranged at one end of the drum of the gearbox.
